(19) United States
(12) Patent Application Publication
(10) Pub. No.: US 2026/0371411 A1
(43) Pub. Date: Nov. 19, 2026

(54) APPARATUS, METHOD, AND COMPUTER PROGRAM

(71) Applicant: Nokia Technologies Oy, Espoo (FI)

(72) Inventors: Jeroen WIGARD, Aalborg (DK); Mads LAURIDSEN, Aalborg (DK); Srinivasan SELVAGANAPATHY, Bangalore (IN); Istvan Zsolt KOVACS, Aalborg (DK); Xiang XU, Beijing (CN)

(21) Appl. No.: 19/103,124

(22) PCT Filed: Aug. 7, 2023
(86) PCT No.: PCT/CN2023/111486

§ 371 Date: Feb. 11, 2025

(30) Foreign Application Priority Data
Aug. 16, 2022 (IN) 202241046361

(51) Int. Cl. H04W 76/10; H04W 36/32

(52) U.S. Cl. CPC H04W 76/10; H04W 36/322

(57) ABSTRACT

There is provided a computer program, method and an apparatus for causing a geostationary first access node to: establish a radio resource control connection between the geostationary first access node and a user equipment, wherein the radio resource control connection is defined by a user context; and provide the user equipment with information relating to when a non-geostationary second access node will be available to provide service coverage to the user equipment using the user context.

### FIELD OF THE DISCLOSURE

The examples described herein generally relate to apparatus, methods, and computer programs, and more particularly (but not exclusively) to apparatus, methods and computer programs for network apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided an apparatus for a geostationary first access node, the apparatus comprising means for performing: establishing a radio resource control connection between the geostationary first access node and a user equipment, wherein the radio resource control connection is defined by a user context; and providing the user equipment with information relating to when a non-geostationary second access node will be available to provide service coverage to the user equipment using the user context.

The apparatus may comprise means for providing the user context to a first proxy node with an indication that the user context is to be stored for retrieval by a non-geostationary second access node.

The means for determining may comprise means for performing: determining that the non-geostationary second access node can fulfil quality of service requirements for communications to and/or from the user equipment better than the geostationary first access node can; determining a battery status of the user equipment to be in a predetermined state and/or to have a remaining energy that is less than a threshold amount; determining that the user equipment has indicated that the user equipment would like communications to be provided through a different radio access technology to that provided by the geostationary first access node; and/or determining a maximum acceptable delay for information to be exchanged between the user equipment and a core network associated with the first and non-geostationary second access nodes allows for communications to be exchanged through the non-geostationary second access node.

The apparatus may comprise means for performing: identifying the non-geostationary second access node and/or an apparatus comprising the non-geostationary second access node; and providing an indication of the non-geostationary second access node and/or the apparatus comprising the non-geostationary second access node to a first proxy node.

The means for identifying the non-geostationary second access node and/or the apparatus comprising the non-geostationary second access node may comprise means for identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

The apparatus may comprise means for performing: suspending the radio resource control connection with the user equipment after providing the user equipment with information relating to when the non-geostationary second access node will be available to provide service coverage to the user equipment using the user context; and subsequently resuming the radio resource control connection with the user equipment using the user context when the non-geostationary second access node is expected to no longer provide a cell covering a location in which the user equipment is located.

The apparatus may comprise means for performing: signalling, to the user equipment, a configuration for causing the user equipment to enter a low power state after said determining to suspend.

The apparatus may comprise means for performing: signalling, to the user equipment, an identifier of the non-geostationary second access node with an indication of a time period during which the non-geostationary second access node is expected to be providing a cell that covers an area in which the user equipment is located.

The means for signalling the identifier of the non-geostationary second access node to the user equipment may comprise means for signalling the identifier of the non-geostationary second access node and said time period during which the non-geostationary second access node is expected to be providing said cell as part of a radio resource control connection release message.

The non-geostationary second access node may be located in a non-geostationary satellite and the means for signalling the identifier of the non-geostationary second access node may comprise means for signalling satellite assistance information for the non-geostationary satellite and/or ephemeris information for the non-geostationary satellite.

The apparatus may comprise means for performing: suspending the radio resource control connection with the user equipment; and retaining the user context at the geostationary first access node after said suspending.

The apparatus may comprise means for providing the user context to the non-geostationary second access node directly via an inter-satellite communication link.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a second aspect, there is provided an apparatus for a first proxy node, the apparatus comprising means for performing: receiving, from a geostationary first access node, a user context that defines a radio resource control connection between the geostationary first access node and a user equipment, and an indication that the user context is to be provided to a non-geostationary second access node; and causing the user context to be provided to the non-geostationary second access node.

The means for causing the user context to be provided to a non-geostationary second access node may comprise means for performing: providing the user context to a second proxy node with an indication that the user context is to be provided to the non-geostationary second access node.

The means for causing the user context to be provided to a non-geostationary second access node may comprise means for performing: providing the user context directly to the non-geostationary second access node.

The apparatus may comprise means for performing receiving an identifier of the non-geostationary second access node from the geostationary first access node.

The apparatus may comprise means for performing receiving the identifier of the non-geostationary second access node as part of receiving a set of identifiers identifying respective access nodes.

The apparatus may comprise means for performing providing the user context to at least two of said respective access nodes.

The apparatus may comprise means for performing identifying the non-geostationary second access node using at least one of: a current location of the user equipment, a trajectory of the user equipment, the ephemeris of an apparatus comprising the non-geostationary second access node, the non-geostationary second access node's trajectory and/or velocity, locations of ground-based gateways to a core network, and/or characteristics of traffic to be transmitted and/or received by the user equipment.

The means for causing the user context to be provided to the non-geostationary second access node may comprise means for causing the user context to be provided to the non-geostationary second access node with an indication of at time at which the user context is to be deleted by the non-geostationary second access node.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a third aspect, there is provided an apparatus for a non-geostationary second access node, the apparatus comprising means for performing: receiving, from a first and/or second proxy node, a user context that defines a radio resource control connection between a geostationary first access node and a user equipment; establishing radio resource control connection between the user equipment and the non-geostationary second access node using the user context; and receiving data from the non-geostationary second access node according to the radio resource control connection.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a fourth aspect, there is provided an apparatus for a user equipment, the apparatus comprising means for performing: establishing a radio resource control connection with a geostationary first access node, the radio resource control connection being defined by a user context; and establishing a radio resource control connection with a non-geostationary second access node using the user context.

The apparatus may comprise means for performing: suspending the radio resource control connection with the geostationary first access node using a radio resource control connection suspend procedure before establishing the radio resource control connection with the non-geostationary second access node; and entering a low power state during at least part of a period of time between said suspending and said resuming.

The apparatus may comprise means for performing: receiving, from the geostationary first access node, a configuration for entering the low power state.

The apparatus may comprise means for performing: receiving, from the geostationary first access node, an identifier of the non-geostationary second access node with an indication of a time period during which the non-geostationary second access node is expected to be providing a cell that covers an area in which the user equipment is located.

The apparatus may comprise means for performing: suspending the radio resource control connection with the non-geostationary second access node when a signal strength between the user equipment and the non-geostationary second access node drops below a threshold amount and/or when a link failure event occurs; and resuming the radio resource control connection with the geostationary first access node using the user context.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a fifth aspect, there is provided an apparatus for a non-geostationary first access node, the apparatus comprising: at least one processor; and at least one memory comprising code that, when executed by the at least one processor causes the apparatus to perform: establishing a radio resource control connection between the geostationary first access node and a user equipment, wherein the radio resource control connection is defined by a user context; and providing the user equipment with information relating to when a non-geostationary second access node will be available to provide service coverage to the user equipment using the user context.

The apparatus may be caused to perform: providing the user context to a first proxy node with an indication that the user context is to be stored for retrieval by a non-geostationary second access node.

The determining may comprise performing: determining that the non-geostationary second access node can fulfil quality of service requirements for communications to and/or from the user equipment better than the geostationary first access node can; determining a battery status of the user equipment to be in a predetermined state and/or to have a remaining energy that is less than a threshold amount; determining that the user equipment has indicated that the user equipment would like communications to be provided through a different radio access technology to that provided by the geostationary first access node; and/or determining a maximum acceptable delay for information to be exchanged between the user equipment and a core network associated with the first and non-geostationary second access nodes allows for communications to be exchanged through the non-geostationary second access node.

The apparatus may be caused to perform: identifying the non-geostationary second access node and/or an apparatus comprising the non-geostationary second access node; and providing an indication of the non-geostationary second access node and/or the apparatus comprising the non-geostationary second access node to a first proxy node.

The identifying the non-geostationary second access node and/or the apparatus comprising the non-geostationary second access node may comprise identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

The apparatus may be caused to perform: suspending the radio resource control connection with the user equipment after providing the user equipment with information relating to when the non-geostationary second access node will be available to provide service coverage to the user equipment using the user context; and subsequently resuming the radio resource control connection with the user equipment using the user context when the non-geostationary second access node is expected to no longer provide a cell covering a location in which the user equipment is located.

The apparatus may be caused to perform: signalling, to the user equipment, a configuration for causing the user equipment to enter a low power state after said determining to suspend.

The apparatus may be caused to perform: signalling, to the user equipment, an identifier of the non-geostationary second access node with an indication of a time period during which the non-geostationary second access node is expected to be providing a cell that covers an area in which the user equipment is located.

The signalling the identifier of the non-geostationary second access node to the user equipment may comprise signalling the identifier of the non-geostationary second access node and said time period during which the non-geostationary second access node is expected to be providing said cell as part of a radio resource control connection release message.

The non-geostationary second access node may be located in a non-geostationary satellite and the signalling the identifier of the non-geostationary second access node may comprise signalling satellite assistance information for the non-geostationary satellite and/or ephemeris information for the non-geostationary satellite.

The apparatus may be caused to perform: suspending the radio resource control connection with the user equipment; and retaining the user context at the geostationary first access node after said suspending.

The apparatus may be caused to perform: providing the user context to the non-geostationary second access node directly via an inter-satellite communication link.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a sixth aspect, there is provided an apparatus for a first proxy node, the apparatus comprising: at least one processor; and at least one memory comprising code that, when executed by the at least one processor causes the apparatus to perform: receiving, from a geostationary first access node, a user context that defines a radio resource control connection between the geostationary first access node and a user equipment, and an indication that the user context is to be provided to a non-geostationary second access node; and causing the user context to be provided to the non-geostationary second access node.

The causing the user context to be provided to a non-geostationary second access node may comprise performing: providing the user context to a second proxy node with an indication that the user context is to be provided to the non-geostationary second access node.

The causing the user context to be provided to a non-geostationary second access node may comprise performing: providing the user context directly to the non-geostationary second access node.

The apparatus may be caused to perform: receiving an identifier of the non-geostationary second access node from the geostationary first access node.

The apparatus may be caused to perform: receiving the identifier of the non-geostationary second access node as part of receiving a set of identifiers identifying respective access nodes.

The apparatus may be caused to perform: providing the user context to at least two of said respective access nodes.

The apparatus may be caused to perform: identifying the non-geostationary second access node using at least one of: a current location of the user equipment, a trajectory of the user equipment, the ephemeris of an apparatus comprising the non-geostationary second access node, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at time at which the user context is to be deleted by the non-geostationary second access node.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a seventh aspect, there is provided an apparatus for a non-geostationary second access node, the apparatus comprising: at least one processor; and at least one memory comprising code that, when executed by the at least one processor causes the apparatus to perform: receiving, from a first and/or second proxy node, a user context that defines a radio resource control connection between a geostationary first access node and a user equipment; establishing radio resource control connection between the user equipment and the non-geostationary second access node using the user context; and receiving data from the non-geostationary second access node according to the radio resource control connection.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to an eighth aspect, there is provided an apparatus for a user equipment, the apparatus comprising: at least one processor; and at least one memory comprising code that, when executed by the at least one processor causes the apparatus to perform: establishing a radio resource control connection with a geostationary first access node, the radio resource control connection being defined by a user context; and establishing a radio resource control connection with a non-geostationary second access node using the user context.

The apparatus may be caused to perform: suspending the radio resource control connection with the geostationary first access node using a radio resource control connection suspend procedure before establishing the radio resource control connection with the non-geostationary second access node; and entering a low power state during at least part of a period of time between said suspending and said resuming.

The apparatus may be caused to perform: receiving, from the geostationary first access node, a configuration for entering the low power state.

The apparatus may be caused to perform: receiving, from the geostationary first access node, an identifier of the non-geostationary second access node with an indication of a time period during which the non-geostationary second access node is expected to be providing a cell that covers an area in which the user equipment is located.

The apparatus may be caused to perform: suspending the radio resource control connection with the non-geostationary second access node when a signal strength between the user equipment and the non-geostationary second access node drops below a threshold amount and/or when a link failure event occurs; and resuming the radio resource control connection with the geostationary first access node using the user context.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a ninth aspect, there is provided a method for an apparatus for a geostationary first access node, the method comprising: establishing a radio resource control connection between the geostationary first access node and a user equipment, wherein the radio resource control connection is defined by a user context; and providing the user equipment with information relating to when a non-geostationary second access node will be available to provide service coverage to the user equipment using the user context.

The method may comprise providing the user context to a first proxy node with an indication that the user context is to be stored for retrieval by a non-geostationary second access node.

The determining may comprise performing: determining that the non-geostationary second access node can fulfil quality of service requirements for communications to and/or from the user equipment better than the geostationary first access node can; determining a battery status of the user equipment to be in a predetermined state and/or to have a remaining energy that is less than a threshold amount; determining that the user equipment has indicated that the user equipment would like communications to be provided through a different radio access technology to that provided by the geostationary first access node; and/or determining a maximum acceptable delay for information to be exchanged between the user equipment and a core network associated with the first and non-geostationary second access nodes allows for communications to be exchanged through the non-geostationary second access node.

The method may comprise performing: identifying the non-geostationary second access node and/or an apparatus comprising the non-geostationary second access node; and providing an indication of the non-geostationary second access node and/or the apparatus comprising the non-geostationary second access node to a first proxy node.

The identifying the non-geostationary second access node and/or the apparatus comprising the non-geostationary second access node may comprise identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

The method may comprise performing: suspending the radio resource control connection with the user equipment after providing the user equipment with information relating to when the non-geostationary second access node will be available to provide service coverage to the user equipment using the user context; and subsequently resuming the radio resource control connection with the user equipment using the user context when the non-geostationary second access node is expected to no longer provide a cell covering a location in which the user equipment is located.

The method may comprise performing: signalling, to the user equipment, a configuration for causing the user equipment to enter a low power state after said determining to suspend.

The method may comprise performing: signalling, to the user equipment, an identifier of the non-geostationary second access node with an indication of a time period during which the non-geostationary second access node is expected to be providing a cell that covers an area in which the user equipment is located.

The signalling the identifier of the non-geostationary second access node to the user equipment may comprise signalling the identifier of the non-geostationary second access node and said time period during which the non-geostationary second access node is expected to be providing said cell as part of a radio resource control connection release message.

The non-geostationary second access node may be located in a non-geostationary satellite and the signalling the identifier of the non-geostationary second access node may comprise signalling satellite assistance information for the non-geostationary satellite and/or ephemeris information for the non-geostationary satellite.

The method may comprise performing: suspending the radio resource control connection with the user equipment; and retaining the user context at the geostationary first access node after said suspending.

The method may comprise providing the user context to the non-geostationary second access node directly via an inter-satellite communication link.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a tenth aspect, there is provided a method for an apparatus for a first proxy node, the method comprising: receiving, from a geostationary first access node, a user context that defines a radio resource control connection between the geostationary first access node and a user equipment, and an indication that the user context is to be provided to a non-geostationary second access node; and causing the user context to be provided to the non-geostationary second access node.

The causing the user context to be provided to a non-geostationary second access node may comprise performing: providing the user context to a second proxy node with an indication that the user context is to be provided to the non-geostationary second access node.

The causing the user context to be provided to a non-geostationary second access node may comprise performing: providing the user context directly to the non-geostationary second access node.

The method may comprise receiving an identifier of the non-geostationary second access node from the geostationary first access node.

The method may comprise performing receiving the identifier of the non-geostationary second access node as part of receiving a set of identifiers identifying respective access nodes.

The method may comprise performing providing the user context to at least two of said respective access nodes.

The method may comprise performing identifying the non-geostationary second access node using at least one of: a current location of the user equipment, a trajectory of the user equipment, the ephemeris of an apparatus comprising the non-geostationary second access node, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at time at which the user context is to be deleted by the non-geostationary second access node.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to an eleventh aspect, there is provided a method for an apparatus for a non-geostationary second access node, the method comprising: receiving, from a first and/or second proxy node, a user context that defines a radio resource control connection between a geostationary first access node and a user equipment; establishing radio resource control connection between the user equipment and the non-geostationary second access node using the user context; and receiving data from the non-geostationary second access node according to the radio resource control connection.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a twelfth aspect, there is provided a method for an apparatus for a user equipment, the method comprising: establishing a radio resource control connection with a geostationary first access node, the radio resource control connection being defined by a user context; and establishing a radio resource control connection with a non-geostationary second access node using the user context.

The method may comprise performing: suspending the radio resource control connection with the geostationary first access node using a radio resource control connection suspend procedure before establishing the radio resource control connection with the non-geostationary second access node; and entering a low power state during at least part of a period of time between said suspending and said resuming.

The method may comprise performing: receiving, from the geostationary first access node, a configuration for entering the low power state.

The method may comprise performing: receiving, from the geostationary first access node, an identifier of the non-geostationary second access node with an indication of a time period during which the non-geostationary second access node is expected to be providing a cell that covers an area in which the user equipment is located.

The method may comprise performing: suspending the radio resource control connection with the non-geostationary second access node when a signal strength between the user equipment and the non-geostationary second access node drops below a threshold amount and/or when a link failure event occurs; and resuming the radio resource control connection with the geostationary first access node using the user context.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a thirteenth aspect, there is provided an apparatus for a geostationary first access node, the apparatus comprising: establishing circuitry for establishing a radio resource control connection between the geostationary first access node and a user equipment, wherein the radio resource control connection is defined by a user context; and providing circuitry for providing the user equipment with information relating to when a non-geostationary second access node will be available to provide service coverage to the user equipment using the user context.

The apparatus may comprise providing circuitry for providing the user context to a first proxy node with an indication that the user context is to be stored for retrieval by a non-geostationary second access node.

The determining circuitry for determining may comprise: determining circuitry for determining that the non-geostationary second access node can fulfil quality of service requirements for communications to and/or from the user equipment better than the geostationary first access node can; determining circuitry for determining a battery status of the user equipment to be in a predetermined state and/or to have a remaining energy that is less than a threshold amount; determining circuitry for determining that the user equipment has indicated that the user equipment would like communications to be provided through a different radio access technology to that provided by the geostationary first access node; and/or determining circuitry for determining a maximum acceptable delay for information to be exchanged between the user equipment and a core network associated with the first and non-geostationary second access nodes allows for communications to be exchanged through the non-geostationary second access node.

The apparatus may comprise: identifying circuitry for identifying the non-geostationary second access node and/or an apparatus comprising the non-geostationary second access node; and providing circuitry for providing an indication of the non-geostationary second access node and/or the apparatus comprising the non-geostationary second access node to a first proxy node.

The identifying circuitry for identifying the non-geostationary second access node and/or the apparatus comprising the non-geostationary second access node may comprise identifying circuitry for identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

The apparatus may comprise: suspending circuitry for suspending the radio resource control connection with the user equipment after providing the user equipment with information relating to when the non-geostationary second access node will be available to provide service coverage to the user equipment using the user context; and resuming circuitry for subsequently resuming the radio resource control connection with the user equipment using the user context when the non-geostationary second access node is expected to no longer provide a cell covering a location in which the user equipment is located.

The apparatus may comprise: signalling circuitry for signalling, to the user equipment, a configuration for causing the user equipment to enter a low power state after said determining to suspend.

The apparatus may comprise: signalling circuitry for signalling, to the user equipment, an identifier of the non-geostationary second access node with an indication of a time period during which the non-geostationary second access node is expected to be providing a cell that covers an area in which the user equipment is located.

The signalling circuitry for signalling the identifier of the non-geostationary second access node to the user equipment may comprise signalling circuitry for signalling the identifier of the non-geostationary second access node and said time period during which the non-geostationary second access node is expected to be providing said cell as part of a radio resource control connection release message.

The non-geostationary second access node may be located in a non-geostationary satellite and the signalling circuitry for signalling the identifier of the non-geostationary second access node may comprise signalling circuitry for signalling satellite assistance information for the non-geostationary satellite and/or ephemeris information for the non-geostationary satellite.

The apparatus may comprise performing circuitry for performing: suspending the radio resource control connection with the user equipment; and retaining the user context at the geostationary first access node after said suspending.

The apparatus may comprise providing circuitry for providing the user context to the non-geostationary second access node directly via an inter-satellite communication link.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a fourteenth aspect, there is provided an apparatus for a first proxy node, the apparatus comprising: receiving circuitry for receiving, from a geostationary first access node, a user context that defines a radio resource control connection between the geostationary first access node and a user equipment, and an indication that the user context is to be provided to a non-geostationary second access node; and causing circuitry for causing the user context to be provided to the non-geostationary second access node.

The causing circuitry for causing the user context to be provided to a non-geostationary second access node may comprise: providing circuitry for providing the user context to a second proxy node with an indication that the user context is to be provided to the non-geostationary second access node.

The causing circuitry for causing the user context to be provided to a non-geostationary second access node may comprise: providing circuitry for providing the user context directly to the non-geostationary second access node.

The apparatus may comprise receiving circuitry for receiving an identifier of the non-geostationary second access node from the geostationary first access node.

The apparatus may comprise receiving circuitry for receiving the identifier of the non-geostationary second access node as part of receiving a set of identifiers identifying respective access nodes.

The apparatus may comprise providing circuitry for providing the user context to at least two of said respective access nodes.

The apparatus may comprise identifying circuitry for identifying the non-geostationary second access node using at least one of: a current location of the user equipment, a trajectory of the user equipment, the ephemeris of an apparatus comprising the non-geostationary second access node, the non-geostationary second access node's trajectory and/or velocity, locations of ground-based gateways to a core network, and/or characteristics of traffic to be transmitted and/or received by the user equipment.

The causing circuitry for causing the user context to be provided to the non-geostationary second access node may comprise causing circuitry for causing the user context to be provided to the non-geostationary second access node with an indication of at time at which the user context is to be deleted by the non-geostationary second access node.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a fifteenth aspect, there is provided an apparatus for a non-geostationary second access node, the apparatus comprising: receiving circuitry for receiving, from a first and/or second proxy node, a user context that defines a radio resource control connection between a geostationary first access node and a user equipment; establishing circuitry for establishing radio resource control connection between the user equipment and the non-geostationary second access node using the user context; and receiving circuitry for receiving data from the non-geostationary second access node according to the radio resource control connection.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a sixteenth aspect, there is provided an apparatus for a user equipment, the apparatus comprising: establishing circuitry for establishing a radio resource control connection with a geostationary first access node, the radio resource control connection being defined by a user context; and establishing circuitry for establishing a radio resource control connection with a non-geostationary second access node using the user context.

The apparatus may comprise: suspending circuitry for suspending the radio resource control connection with the geostationary first access node using a radio resource control connection suspend procedure before establishing the radio resource control connection with the non-geostationary second access node; and circuitry for entering a low power state during at least part of a period of time between said suspending and said resuming.

The apparatus may comprise: receiving circuitry for receiving, from the geostationary first access node, a configuration for entering the low power state.

The apparatus may comprise: receiving circuitry for receiving, from the geostationary first access node, an identifier of the non-geostationary second access node with an indication of a time period during which the non-geostationary second access node is expected to be providing a cell that covers an area in which the user equipment is located.

The apparatus may comprise: suspending circuitry for suspending the radio resource control connection with the non-geostationary second access node when a signal strength between the user equipment and the non-geostationary second access node drops below a threshold amount and/or when a link failure event occurs; and resuming circuitry for resuming the radio resource control connection with the geostationary first access node using the user context.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a seventeenth aspect, there is provided non-transitory computer readable medium comprising program instructions for causing an apparatus for a non-geostationary first access node to perform at least the following: establishing a radio resource control connection between the geostationary first access node and a user equipment, wherein the radio resource control connection is defined by a user context; and providing the user equipment with information relating to when a non-geostationary second access node will be available to provide service coverage to the user equipment using the user context.

The apparatus may be caused to perform: providing the user context to a first proxy node with an indication that the user context is to be stored for retrieval by a non-geostationary second access node.

The determining may comprise performing: determining that the non-geostationary second access node can fulfil quality of service requirements for communications to and/or from the user equipment better than the geostationary first access node can; determining a battery status of the user equipment to be in a predetermined state and/or to have a remaining energy that is less than a threshold amount; determining that the user equipment has indicated that the user equipment would like communications to be provided through a different radio access technology to that provided by the geostationary first access node; and/or determining a maximum acceptable delay for information to be exchanged between the user equipment and a core network associated with the first and non-geostationary second access nodes allows for communications to be exchanged through the non-geostationary second access node.

The apparatus may be caused to perform: identifying the non-geostationary second access node and/or an apparatus comprising the non-geostationary second access node; and providing an indication of the non-geostationary second access node and/or the apparatus comprising the non-geostationary second access node to a first proxy node.

The identifying the non-geostationary second access node and/or the apparatus comprising the non-geostationary second access node may comprise identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

The apparatus may be caused to perform: suspending the radio resource control connection with the user equipment after providing the user equipment with information relating to when the non-geostationary second access node will be available to provide service coverage to the user equipment using the user context; and subsequently resuming the radio resource control connection with the user equipment using the user context when the non-geostationary second access node is expected to no longer provide a cell covering a location in which the user equipment is located.

The apparatus may be caused to perform: signalling, to the user equipment, a configuration for causing the user equipment to enter a low power state after said determining to suspend.

The apparatus may be caused to perform: signalling, to the user equipment, an identifier of the non-geostationary second access node with an indication of a time period during which the non-geostationary second access node is expected to be providing a cell that covers an area in which the user equipment is located.

The signalling the identifier of the non-geostationary second access node to the user equipment may comprise signalling the identifier of the non-geostationary second access node and said time period during which the non-geostationary second access node is expected to be providing said cell as part of a radio resource control connection release message.

The non-geostationary second access node may be located in a non-geostationary satellite and the signalling the identifier of the non-geostationary second access node may comprise signalling satellite assistance information for the non-geostationary satellite and/or ephemeris information for the non-geostationary satellite.

The apparatus may be caused to perform: suspending the radio resource control connection with the user equipment; and retaining the user context at the geostationary first access node after said suspending.

The apparatus may be caused to perform: providing the user context to the non-geostationary second access node directly via an inter-satellite communication link.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to an eighteenth aspect, there is provided non-transitory computer readable medium comprising program instructions for causing an apparatus for a proxy node to perform at least the following: receiving, from a geostationary first access node, a user context that defines a radio resource control connection between the geostationary first access node and a user equipment, and an indication that the user context is to be provided to a non-geostationary second access node; and causing the user context to be provided to the non-geostationary second access node.

The causing the user context to be provided to a non-geostationary second access node may comprise performing: providing the user context to a second proxy node with an indication that the user context is to be provided to the non-geostationary second access node.

The causing the user context to be provided to a non-geostationary second access node may comprise performing: providing the user context directly to the non-geostationary second access node.

The apparatus may be caused to perform: receiving an identifier of the non-geostationary second access node from the geostationary first access node.

The apparatus may be caused to perform: receiving the identifier of the non-geostationary second access node as part of receiving a set of identifiers identifying respective access nodes.

The apparatus may be caused to perform: providing the user context to at least two of said respective access nodes.

The apparatus may be caused to perform: identifying the non-geostationary second access node using at least one of: a current location of the user equipment, a trajectory of the user equipment, the ephemeris of an apparatus comprising the non-geostationary second access node, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at time at which the user context is to be deleted by the non-geostationary second access node.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a nineteenth aspect, there is provided non-transitory computer readable medium comprising program instructions for causing an apparatus for a non-geostationary second access node to perform at least the following: receiving, from a first and/or second proxy node, a user context that defines a radio resource control connection between a geostationary first access node and a user equipment; establishing radio resource control connection between the user equipment and the non-geostationary second access node using the user context; and receiving data from the non-geostationary second access node according to the radio resource control connection.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a twentieth aspect, there is provided non-transitory computer readable medium comprising program instructions for causing an apparatus for a user equipment to perform at least the following: establishing a radio resource control connection with a geostationary first access node, the radio resource control connection being defined by a user context; and establishing a radio resource control connection with a non-geostationary second access node using the user context.

The apparatus may be caused to perform: suspending the radio resource control connection with the geostationary first access node using a radio resource control connection suspend procedure before establishing the radio resource control connection with the non-geostationary second access node; and entering a low power state during at least part of a period of time between said suspending and said resuming.

The apparatus may be caused to perform: receiving, from the geostationary first access node, a configuration for entering the low power state.

The apparatus may be caused to perform: receiving, from the geostationary first access node, an identifier of the non-geostationary second access node with an indication of a time period during which the non-geostationary second access node is expected to be providing a cell that covers an area in which the user equipment is located.

The apparatus may be caused to perform: suspending the radio resource control connection with the non-geostationary second access node when a signal strength between the user equipment and the non-geostationary second access node drops below a threshold amount and/or when a link failure event occurs; and resuming the radio resource control connection with the geostationary first access node using the user context.

The first and/or second proxy node may be at least one of: a ground-based gateway to a core network, a database located in a core network, an access and mobility management function, and/or a Mobility Management Entity.

The user context may comprise at least one of: a radio resource control configuration for the user equipment, access stratum security key information, and/or an identifier of an access node that was previously serving the user equipment.

According to a twenty first aspect, there is provided a computer program product stored on a medium that may cause an apparatus to perform any method as described herein.

According to a twenty second aspect, there is provided an electronic device that may comprise apparatus as described herein.

According to a twenty third aspect, there is provided a chipset that may comprise an apparatus as described herein.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIG. 6 illustrates noise at different frequencies;

FIG. 7 illustrates an example scenario;

FIG. 8 illustrates example signalling that may be performed by apparatus described herein; and

FIGS. 9 to 12 are flow charts illustrating example operations that may be performed by apparatus described herein.

### DETAILED DESCRIPTION

In the following description of examples, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals).

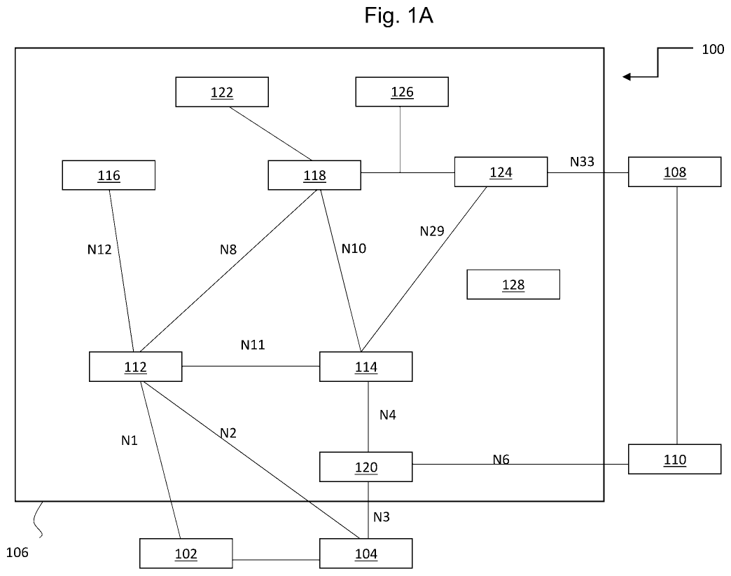

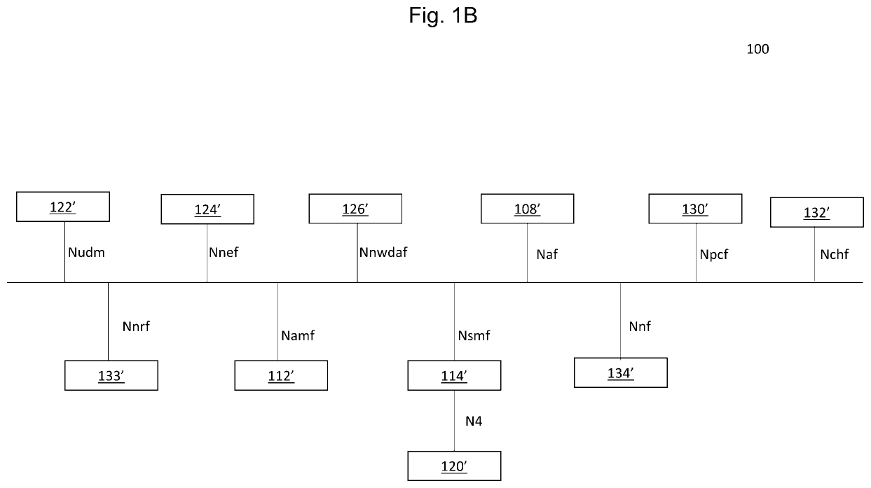

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representations of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

3GPP refers to a group of organizations that develop and release different standardized communication protocols. 3GPP develops and publishes documents pertaining to a system of “Releases” (e.g., Release 15, Release 16, and beyond).

Non-terrestrial networks (NTN) refers to networks that can providing connectivity to a core network through space-borne vehicles (such as satellites) and/or through airborne platforms. These networks may thus provide radio connectivity between a User Equipment (UE) on the ground and the vehicle/platform.

NTN have been defined for New Radio and Narrow Band (NB)-Internet of Things (IoT)/enhanced Machine Type Communications (eMTC) in 3GPP's Release 17. As part of preparations for Release 18, companies submitted further proposals for NTN in a 3GPP framework.

One potential operation/use case relates to a store and forward operation for IoT NTN.

Store-and-forward (S&F) is a new feature that will allow a satellite to provide service to IoT NTN devices even in periods/areas when/where the satellite is not connected to a Gateway on the ground for connecting the satellite to the core network. An eNB-on-board architecture is assumed such that the satellite is assumed to comprise radio access node (RAN) functionality such that the UE treats the satellite as a RAN node. There is a feeder link that is a link connecting the satellite (comprising an eNB) and the Gateway (which is then connected to the core network). There is also a service link that is a link connecting the satellite (eNB) and the UE. Non-simultaneous operation of the service link and the feeder link is also assumed to be supported. Messages received by the satellite during the time period during which the satellite is unconnected to a land-based gateway may be stored on board the satellite until there is a line of sight with the gateway. To help support this, decoupled signalling procedures may be included in the 3GPP framework (e.g., support for signalling between a UE and a satellite with an onboard Radio Access Network (RAN) node, and, independent to this, support for signalling between the satellite with an onboard RAN node and a gateway to the core network entity. It would also be useful to support dynamic attachment between the gateway and the satellite.

Dynamic attachment refers to a dynamic connection setup and/or dynamic connection release. In the present example, dynamic attachment provides support for the feeder link between the eNB on the satellite and a core network connection point (e.g., a non-terrestrial network gateway) being unavailable at times. In contrast, terrestrial-based access points always have access to a core network. It is understood that techniques described in the following in relation to satellites comprising an access point may be applied to any access point to a core network that has intermittent access to the core network.

The store and forward operation builds on the Release 17 concept of discontinuous coverage scenario in which the UE only occasionally and temporarily has coverage from a satellite. The discontinuous coverage scenario is expanded by the store and forward operation to also define that the satellite is not always connected with the core network.

The store and forward architecture may enable a low-cost deployment that comprises just a few satellites and a few ground stations. This means the connectivity cost per device can be further reduced at the cost of only being able to support delay tolerant data relative to current NTN architectures.

A key challenge in the store and forward deployment is how the UE can establish a secure connection with a core network when the link between the UE and the satellite and the link between the satellite and the core network are not available simultaneously.

The store and forward concept is only applicable for non-geostationary satellites as they move. Non-geostationary satellites are often low earth orbit satellites that are located at altitudes of 300-1500 km. This is because geostationary (GEO) satellites don't move relative to Earth. Geostationary satellites (which are often located at altitudes of about 36000 km) suffer from a much weaker link budget than non-geostationary satellites, which makes it very hard to achieve a targeted data throughput (e.g., 10 kps or lower), especially in the uplink. With a normal handset, repeated transmissions will often be needed to reach the satellite. In contrast, low earth orbit (LEO) satellites may achieve throughputs of 100-600 kbps from a normal handheld under high load conditions. This is why it is often preferable to use non-geostationary LEO satellites for data transmission than it is to use GEO satellites. The quality “link budget” expresses all of the gain and losses of a communication signal from source to target. As the distance between a GEO satellite and a UE is larger than between LEO satellite and UE, the loss is larger across the link between the UE and the GEO satellite than it is between the UE and the LEO satellite. This is represented by respective metrics for the link budgets that indicate that the link budget is weaker for the link between the GEO satellite and the UE in comparison to the link budget for the link between the LEO satellite and the UE.

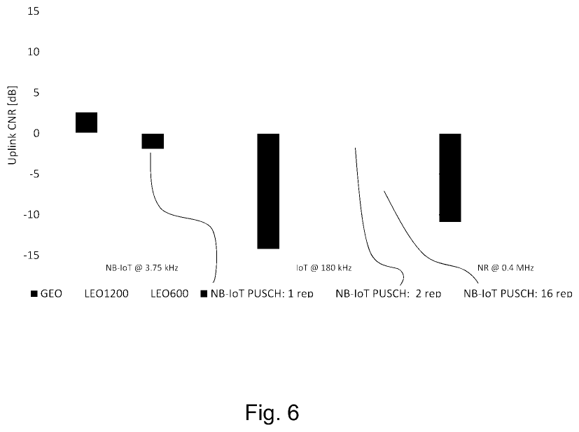

This is illustrated with respect to FIG. 6.

FIG. 6 illustrates an uplink Carrier to Noise Ratio (CNR) for different transmission bandwidths and satellite altitudes, with the different transmission bandwidths corresponding to narrowband-Internet of Things (NB-IoT), Internet of Things (IoT), and New Radio (NR). The satellites are labelled as GEO (representing a geostationary satellite at an altitude of about 3600 km), LEO 1200 (representing a non-stationary LEO satellite at an altitude of about 1200 km), and LEO 600 (representing a non-geostationary LEO satellite at an altitude of about 600 km).

FIG. 6 illustrates that a NB-IoT communicating with GEO via a single tone can achieve 2.6 dB, while using a full physical resource block (PRB) in IoT would result in −14.2 dB. Switching to a LEO satellite at 600 km improves the CNR to −0.9 dB.

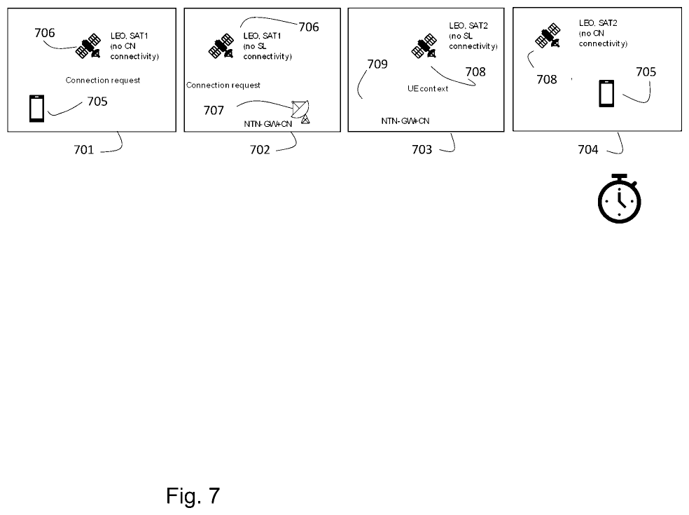

There is also a potentially long connection setup time for a store and forward constellation using LEO satellites. This is illustrated with respect to FIG. 7.

FIG. 7 illustrates signalling connections at a first time 701, a second time 702, a third time 703, and a fourth time 704.

During the first time 701, there is shown a UE 705 that is transmitting a connection request to a first LEO satellite 706 as the UE 705 has data to transmit uplink. During the first time 701, the first LEO satellite 706 does not have a connection to a core network.

During the second time 702, the first LEO satellite 706 obtains a connection to a core network via a gateway 707. During this time, the first LEO satellite 706 does not have a service link (SL) connectivity. The first LEO satellite 706 signals a connection request to the first gateway 707. The first LEO satellite 706 may provide the first gateway 707 with the UE context.

During the third time 703, a second LEO satellite 708 is in communication with a second gateway 709. The second gateway 709 may be the same as the first gateway 707 or different to the first gateway 707. The second gateway 709 provides a UE context to the second LEO satellite 708, where the UE context is usable by the UE 705 for a connection to the core network. The second LEO satellite 708 does not have service link connectivity. It is understood that although the example of FIG. 7 refers to a second LEO satellite 708, this second LEO satellite may be the first LEO satellite 706 or a different LEO satellite to the first LEO satellite. This example is merely for illustrative purposes.

During the fourth time, the second LEO satellite 708 exchanges data with the UE 705 using the UE context. During the fourth time, the second LEO satellite 708 does not have connectivity to the core network.

In the example of FIG. 7, the connection setup time is long as the first LEO satellite needs to be in communication reach of the first gateway 707, where it can connect to the core network, and then, after the core network provides the second LEO satellite with the UE context as part of a connection request response, the second LEO satellite 708 needs to be in communication range of the UE 705 to provide the UE context.

Depending on the type of access being requested by the UE 705 in the initial connection request message made during 701 (for example, the connection request may be a request to establish a Radio Resource Control (RRC) connection or to resume an RRC resume, e.g. with Early or Small Data Transmission using Random Access Channel (RACH) resources or Preconfigured Uplink resources), the node in which the access takes place (last serving node vs a target node), and the level of security, the number of control plane messages exchanged between the UE 705 and the core network for establishing a connection/UE context may be rather large. The UE context has to be established (and hence the communications performed) before the actual user plane data transfer can start. The exact delay resulting from a UE communicating with a core network via at least one satellite will depend on the satellite constellation and can be several hours.

The following aims to address at least one of the above-mentioned issues. In particular, the following aims to utilize a geostationary satellite to address at least one of the above-mentioned issues.

Connecting simultaneously to different systems, where one system does not connect to a 3GPP core network, is known from LTE-WiFi interworking, and includes data offloading to the WiFi system. In those cases, the data transfer over WiFi is completely transparent to the 3GPP system, so the 3GPP does not know that data transfer is occurring through a WiFi network. This interworking architecture also results in data leaving the secure 3GPP system, which makes it more susceptible to interference and/or interception. However, one of the biggest differences in the present disclosure in comparison to LTE-WiFi interworking scenario is that in this NTN scenario, the radio access to one of the systems comes and goes in time (even when the UE is not moving) while another system in the NTN scenario is able to control/monitor how far the data transmission from the UE has been completed.

To address at least one of the above-mentioned issues, the following describes a signalling mechanism in which a UE and/or a network can propose to utilise a non-geostationary/LEO satellite when at least one predetermined condition is fulfilled. The non-geostationary satellite is described herein in connection with the store and forward operation. However, it is understood that the presently described techniques may be applied to non-geostationary/LEO satellites that are not currently configured to operate using the store and forward mechanisms. Furthermore, although the following examples are described in the context of NB-IoT. However, it is understood that the presently described mechanisms may be applied to other transmission bands/systems, such as, for example, enhanced Machine Type Communications (eMTC) or New Radio (NR).

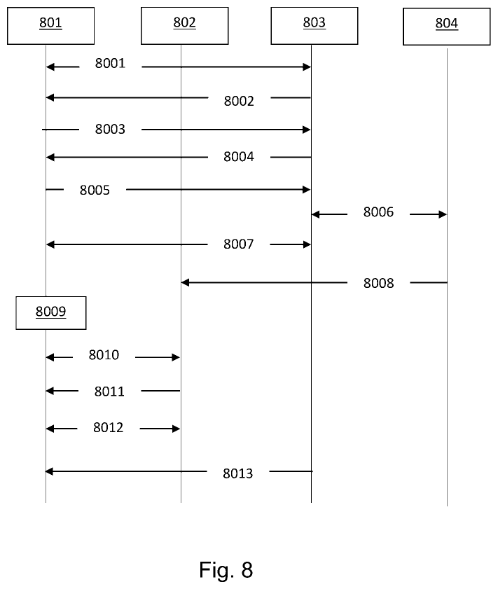

This is illustrated with respect to the signalling diagram of FIG. 8.

FIG. 8 illustrates signalling that may be performed between a UE 801, a LEO satellite 802, a GEO satellite 803, and a core network 804. The LEO satellite 802 and GEO satellite 803 may comprise respective access points for facilitating access to the core network 804. It is therefore understood that references in FIG. 8 to either of these satellites may refer to their respective access points.

During 8001, the UE 801 signals the GEO satellite 803. This signalling may comprise a Random Access Preamble. This signalling of 8001 may correspond to a new radio random access procedure.

During 8002, the Geo satellite 803 responds to the signalling of 8001. The signalling of 8001 may comprise a Random Access Response.

During 8003, the UE 801 signals the GEO satellite 803. This signalling of 8003 may comprise an RRC connection request service operation. Relative to currently known RRC connection request signalling, the signalling of 8003 may comprise information indicating that the UE 801 wants to connect to LEO, such as a store-and-forward LEO. This signalling of 8003 may comprise information indicating a maximum acceptable delay for the information exchange. This maximum acceptable delay may be dependent on at least one of a plurality of different factors, such as, for example, an application associated with data to be transmitted uplink, a Quality of Service associated with the data to be transmitted uplink, the amount of data to be exchanged, a current UE battery status, and/or a determination by the UE to utilize a different Radio Access Technology (RAT) via the LEO satellite (such as, for example, eMTC or NR when the initial access to GEO is NB-IoT to optimize the link budget).

Therefore, the RRC connection request from the UE may comprise at least one of the following elements.

First, the request may comprise information indicating a maximum delay for information to be exchanged by the UE 801. This maximum delay may be used by the core network and/or the GEO satellite to estimate whether a LEO satellite will be close enough within a time frame for the data to be transmitted and/or received within the maximum delay. When it is determined that there will be a LEO satellite within range within the maximum delay time, the core network and/or the GEO satellite may determine to provide an indication of that LEO satellite to the UE 801. When it is determined that there will not be a LEO satellite within range within the maximum delay time, the core network and/or the GEO satellite my determine to provide an indication to the UE to the effect that the UE should try to upload the data to the core network and/or the GEO satellite through the GEO satellite (and not via a LEO satellite).

Second, the request may comprise an indication of an amount of data to be exchanged by the UE 801. The core network and/or the GEO satellite may use this indicated amount of data, a knowledge of GEO satellite throughput, a knowledge of the LEO satellite's throughput, an indication of a time period during which the LEO satellite is expected to be within communication range of the UE 801, and respective indication of delay times for that amount of data to be transmitted through each of the GEO satellite and the LEO satellite to determine whether to cause the amount of data to be transmitted through the GEO satellite and/or the LEO satellite.

Third, the request may comprise an indication of the UE's battery status and/or usage. The battery usage for uploading a certain amount of data is different for transmission via a LEO satellite compared to transmission via a GEO satellite. This is because transmitting data uplink via a LEO satellite uses less battery than transmitting data uplink via a GEO satellite as the LEO satellite is closer to the ground than the GEO satellite. Therefore, when the core network and/or the GEO satellite determines that the UE's battery should be optimized (e.g., when the UE's current battery status is low, and/or when the UE is not currently charging), the core network and/or the GEO satellite may be more likely to cause the UE to transmit uplink data through the LEO satellite instead of through the GEO satellite.

Fourth, the request may comprise an indication that the UE wants to use a specific radio access technology, where the specific radio access technology is available via the LEO satellite and is not available via the GEO satellite. This indication may be used, for example, when NB-IoT is used by the UE to access the GEO satellite (e.g., to overcome the link budget), but a LEO satellite may provide access to the core network via, for example, enhanced Machine Type Communications). The core network and/or the GEO satellite may use this information for selecting a LEO satellite that is able to provide the requested access network type request.

Fifth, the request may comprise an indication that the UE expects to receive downlink data, that is not delay critical. Data that is not delay critical may be suitable to be provided via a store and forward LEO satellite, and therefore this information may be used by the core network and/or the GEO satellite to select a satellite through which the UE should communicate that data with the core network and/or the GEO satellite.

During 8004, the GEO satellite 803 responds to the signalling of 8003. The signalling of 8004 may comprise an RRC Connection Setup signalling operation. The RRC connection Setup signalling of 8004 may comprise an indication informing the UE 801 that the connection being set up may use the LEO satellite 802 for communicating with the core network 804. This indication may be provided based on a determination by the core network and/or the GEO satellite using the information comprised in the request, as indicated above. The signalling of 8004 may comprise an indication informing the UE 801 that it is better for the UE 801 to use GEO satellite 803 for communicating with the core network 804. The indication provided to the UE 801 during 8004 may be selected in dependence on the information received from the UE 801 during 8003.

During 8005, the UE 801 signals the GEO satellite 803. This signalling of 805 may comprise an RRC Connection Setup Complete service operation. The signalling of 8005 may comprise an indication that the UE 801 has understood the connection setup signalling of 8004. When the signalling of 8004 indicates that LEO satellite 802 may be used for communicating with the core network 804, the signalling of 8005 may comprise an indication that the UE 804 is ready to use the LEO satellite 802 when the next LEO satellite is detected by the UE 801.

During 8006, the GEO satellite 803 exchanges signalling with the core network 804. This signalling of 8006 may relate to establishing a connection to the core network 804 on behalf of the UE 801. The signalling of 8006 may comprise, for example, information relating to registration of the UE 801, authentication of the UE 801, setup of non-access stratum (NAS)/core network context, and/or security context. The GEO satellite 803 may receive information identifying LEO satellite 805 from the core network 804 during 8006. The LEO satellite 802 may be identified by the core network in dependence on information maintained by the core network 804 regarding the trajectory of the LEO satellite 805 and information relating to when the UE intends to transmit and/or receive information via a LEO satellite.

During 8007, the GEO satellite 803 signals the UE 801. The signalling of 8007 may comprise information relating to the LEO satellite 803. For example, the signalling of 8007 may comprise information indicating a time (e.g., using Coordinated Universal Time (UTC) or relative time delay) of when LEO satellite 802 is expected to be available to the UE 801 for communication of data. The signalling of 8007 may comprise a configuration for causing the UE to enter a low power mode (such as, for example, discontinuous reception, PSM, etc.) until the LEO satellite 802 is available.

The signalling of 8007 may comprise an indication for causing the UE 801 to switch or change its idle priority to LEO cells on receipt of the signalling of 8007. This is to avoid UE monitoring or camping onto GEO cell whose coverage may be better than LEO in discontinuous coverage scenario.

The signalling of 8007 may be performed in a variety of different ways and/or using any or a plurality of different service operations. As one example, an RRCConnectionRelease service operation may be enhanced relative to its current definition in order to redirect the UE 801 to the LEO satellite during 8007. This may be performed by including information associated with and/or identifying the LEO satellite (e.g., a time when the LEO satellite is available), in the RRCConnection Release message. As another example, the RRC Reconfiguration service operation may be enhanced to effect the signalling of 8007.

As an example, the signalling of 8007 may comprise a GEO System Information Block (SIB) with an advertisement table for NTN from different domains (e.g., different public land mobile networks (PLMNs). This GEO SIB may comprise information to optimize the cell search. It is understood that the term SIB is used here even though the provided GEO SIB provides information for another system (e.g., for the LEO satellite), as the signalling may be based on the same principles as SIB (broadcast within the GEO cell area). This GEO SIB will also be referred to herein as a LEO advertisement SIB.

Service providers in the network may be configured to exchange information with other service providers to acquire updated information to be provided in the SIB, and to transmit the new SIB.

During 8008, the core network 804 exchanges signalling with the LEO satellite 802. This signalling of 8008 may provide the UE context from the core network 804 to the LEO satellite 802. This signalling of 8008 may comprise Access Stratum (AS) context/security context already established for the UE in the GEO satellite 803, and/or other information for enabling the LEO satellite 802 to resume an RRC connection with the UE 801.

For the current operating specification of NB-IoT, the connection to the GEO satellite 803 is released first. It may also be that this can be done simultaneously in future release or for some other Radio Access Technologies. Some further examples for this are described later.

During 8009, the UE 801 may enter an energy saving state (such as, for example, a sleep state, an idle state (e.g., an RRC IDLE state), and/or an inactive state (e.g., an RRC INACTIVE state)). This energy saving state may be maintained by the UE 801 until the time when the indicated LEO satellite 802 is expected to become detectable by the UE.

At 8010, the UE 801 signals a random access channel access request and/or paging procedure to the LEO satellite 802. This may occur during a time period during which the UE 801 expects the LEO satellite to be available to the UE 801 for communications. It is understood that although this example shows the UE 801 paging the LEO satellite, that the LEO satellite 802 may instead page the UE 801 during 8010. It is understood that although this is illustrated with respect to random access procedures, hat other types of access procedures may be used by the UE for initiating a connection with the LEO satellite 802 for connection to the core network.

During 8010, the LEO satellite 802 has the UE context (e.g., the AS security parameters), as received from the GEO satellite 803 via the core network 804. The LEO satellite 802 may use the received UE context to connect with the UE 801 faster than without use of the UE context. For example, the RRC Connection Resume procedure may be performed using the received UE context to connect with the UE. Importantly, this RRC connection may be made between the UE and the LEO satellite 802 without the LEO satellite 802 currently having an active connection with the core network 804, whose connectivity to the LEO satellite 802 may not be available at this time.

During 8011, the LEO satellite 802 signals the UE 801. This signalling of 8011 may correspond to the LEO satellite 802 scheduling the UE 801 for transmit and/or receive operations according to a radio access node located on the LEO satellite 802.

During 8012, the UE 801 and the LEO satellite 802 exchange signalling according to the scheduling of 8011.

Between 8012 and 8013, the LEO satellite 802 becomes either undetectable to the UE 801, or the UE 801 determines that a signal strength of communications between the UE 801 and the LEO satellite 802 has fallen below a threshold amount. In this case, the UE 801 determines whether or not the UE 801 has transmitted and/or received all of the data the UE 801 has intended to transmit and/or receive.

When the UE 801 determines that the UE 801 has transmitted and/or received all of the data the UE 801 has intended to transmit and/or receive, the UE 801 may enter an energy saving mode (e.g., an inactive and/or sleep mode).

When the UE 801 determines that the UE 801 has not transmitted and/or received all of the data the UE 801 has intended to transmit and/or receive, the UE 801 may indicate to the GEO satellite 803 and/or the LEO satellite 802 that the UE 801 has more data to be transmitted and/or received by the UE 801.

Subsequent to this, at 8013, signalling may be performed in accordance with step 8001 (including subsequent signalling) or 8007 (including subsequent signalling).

In the above example of FIG. 8, on the UE side, the UE may initially scan radio frequency channels to search for a network. When the UE cannot find a home PLMN or an enhanced home PLMN but can find a roaming PLMN that supports the LEO advertisement SIB (e.g., a GEO cell, the UE may:
update a list of preferences for PLMN selection (as defined in 3GPP TS 23.122), creating a new criteria that moves up neighbor PLMNs that support the LEO advertisement SIB;
Camp on a PLMN associated with the LEO advertisement SIB, and read the assistance information provided in the LEO advertisement SIB;
Not try to register in the network, such that legacy procedures in 3GPP mandating registration (and associated counters, log of failures, etc.) are by-passed; and
Determine a time to wake up again and information for optimizing cell search in the LEO network based on the information in the LEO advertising SIB.

After the UE disconnects from the LEO network, the UE may initiate an internal timer for the validity of the ephemeris acquired for future discoveries of the LEO network. The length of the timer may depend on a level of details provided by the LEO ephemeris, and the aging of this information. The LEO network may have precedence in a new PLMN search while the timer is still valid. When the timer expires, the UE may initiate a PLMN search with the PLMN associated to the GEO cell (more stable in continuity, time and frequency offsets).

For all of the above examples, for the deployment scenario where the GEO and at least one LEO satellites comprise respective gNBs for serving the UE (where the GEO satellite may provide complete/continuous coverage while the at least one LEO satellite provides discontinuous coverage with support for store and forward (SF)), the UE may be configured to select to connect to a core network using a cell provided by the GEO satellite when the UE has an uplink non-access stratum transmission to be made (.e., when the UE has control plane data to provide upstream). The UE may be further configured to select to connect to a core network using a cell provided by the GEO satellite when the UE has uplink data transmissions to be made (i.e., when the UE has user plane data to provide upstream).

Also in the above examples, the GEO satellite may retain/preserve the UE context when the GEO satellite transfers the UE context to the LEO satellite via the core network. Further, whenever the UE context is updated at the LEO satellite (e.g., due to an RRC Resume procedure being performed), the core network may update the UE context retained by the GEO satellite for enabling the GEO satellite to be able to handle direct non-access stratum signalling from the UE without SF.

Although the above example was described in the context of for NB-IoT and the UE disconnecting from the GEO satellite before connecting to the LEO satellite, it is understood that this is merely used as an example and that other radio access technologies and/or mechanisms for causing the UE to prefer another satellite to a GEO satellite to provide access to a core network. For example, the radio access technology being considered may be enhanced Machine Type Communications and/or New Radio. Further, the procedure causing the UE to switch from a GEO satellite to a LEO satellite may be a Conditional Handover procedure of the like.

Furthermore a UE may have the capability of having simultaneous connections to the GEO satellite and the LEO satellite. In this case, the radio access technologies used by the UE to access the different types of satellite may be the same or different. For example, the UE may use NB-IoT to communicate with the GEO satellite while simultaneously using eMTC and/or NR to communicate with the LEO satellite.

In all of the above examples, the GEO satellite may broadcast that the GEO satellite is able to support facilitation of Store and Forward Non-GEO Satellite orbit (NGSO) satellites, such the UE knows this is an option.

Optionally, the GEO satellite may provide the UE with further information on potential delays, and/or availability of the Store and Forward NGSO satellites.

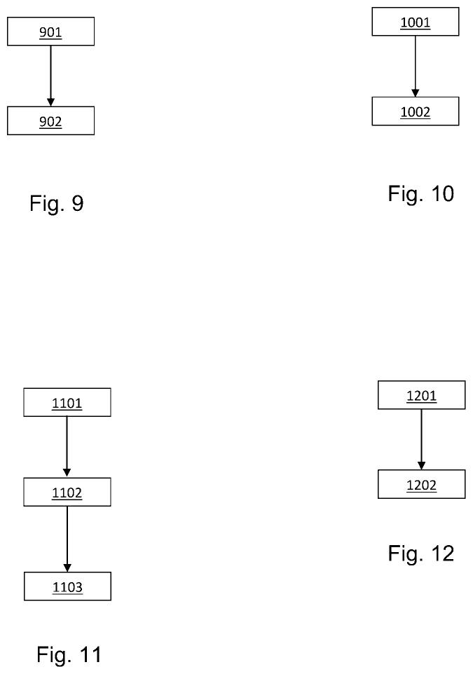

FIGS. 9 to 12 illustrate aspects of the above examples. It is therefore understood that features described above in relation to the previous examples may be implemented in the following aspects.

FIG. 9 illustrates operations that may be performed by an apparatus for a non-geostationary first access node. The non-geostationary access node may be configured to provide a service/service provision area to a user equipment while the user equipment is located in that service/service provision area. The service/service provision area may correspond to a coverage area defined by at least one cell provided by that non-geostationary first access node. The non-geostationary first access node may interact with the apparatus of any of FIGS. 10 to 12. It is understood that although the terms geostationary and non-geostationary are used throughout in relation to various apparatus, that these terms do not mandate that those apparatus are located on or in a satellite/satellite orbit. For example, a geostationary apparatus may be considered to be an apparatus that maintains a fixed displacement with respect to a fixed location on Earth, while a non-geostationary apparatus may be considered to be an apparatus that varies its displacement with respect to a fixed location on Earth. For example, the geostationary apparatus can be considered as static base station and/or access node, and the non-geostationary apparatus may be considered as a moving base station and/or access node regardless of whether those are mounted on or in a satellite.

During 901, the apparatus establishes a radio resource control connection between the geostationary first access node and a user equipment, wherein the radio resource control connection is defined by a user context. The user context may be a radio access context. By this, it is meant that the user context may define at least one set of parameters for enabling the user equipment to access a network via an access node (e.g., via the first access node).

During 902, the apparatus provides the user equipment with information relating to when a non-geostationary second access node will be available to provide service coverage to the user equipment using the user context.

The providing may be performed directly with the user equipment, or indirectly with the user equipment (e.g., via a proxy node). The apparatus may maintain a radio resource control connection with the user equipment subsequent to providing the user equipment with the user context. For example, the user equipment may be configured to maintain radio resource control connections with multiple access points at a single point in time. The apparatus may suspend a radio resource control connection with user equipment subsequent to providing the user equipment with the user context. For example, the user equipment may be configured to maintain a radio resource control connection with a single access point at a single point in time.

The apparatus may provide the user context to a first proxy node with an indication that the user context is to be stored for retrieval by a non-geostationary second access node.

The determining may comprise: determining that the non-geostationary second access node can fulfil quality of service requirements for communications to and/or from the user equipment better than the geostationary first access node can; determining a battery status of the user equipment to be in a predetermined state and/or to have a remaining energy that is less than a threshold amount; determining that the user equipment has indicated that the user equipment would like communications to be provided through a different radio access technology to that provided by the geostationary first access node; and/or determining a maximum acceptable delay for information to be exchanged between the user equipment and a core network associated with the first and non-geostationary second access nodes allows for communications to be exchanged through the non-geostationary second access node.

The apparatus may identify the non-geostationary second access node and/or an apparatus comprising the non-geostationary second access node; and provide an indication of the non-geostationary second access node and/or the apparatus comprising the non-geostationary second access node to a first proxy node.

The identifying the non-geostationary second access node and/or the apparatus comprising the non-geostationary second access node may comprise identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

The apparatus may suspend the radio resource control connection with the user equipment after providing the user equipment with information relating to when the non-geostationary second access node will be available to provide service coverage to the user equipment using the user context; and subsequently resume the radio resource control connection with the user equipment using the user context when the non-geostationary second access node is expected to no longer provide a cell covering a location in which the user equipment is located.

The apparatus may signal, to the user equipment, a configuration for causing the user equipment to enter a low power state after said determining to suspend. The configuration may be at least part of a radio reconfiguration.

The apparatus may signal, to the user equipment, an identifier of the non-geostationary second access node with an indication of a time period during which the non-geostationary second access node is expected to be providing a cell that covers an area in which the user equipment is located.

The signalling the identifier of the non-geostationary second access node to the user equipment may comprise signalling the identifier of the non-geostationary second access node and said time period during which the non-geostationary second access node is expected to be providing said cell as part of a radio resource control connection release message.

The non-geostationary second access node may be located in a non-geostationary satellite and the signalling the identifier of the non-geostationary second access node may comprise signalling satellite assistance information for the non-geostationary satellite and/or ephemeris information for the non-geostationary satellite.

The apparatus may suspend the radio resource control connection with the user equipment; and retain the user context at the geostationary first access node after said suspending.

The apparatus may provide the user context to the non-geostationary second access node directly via an inter-satellite communication link.

FIG. 10 illustrates operations that may be performed by an apparatus for a first proxy node. The first proxy node may be as described above in relation to FIG. 9. The first proxy node may interact with the apparatus of any of FIGS. 9, 11, and/or 12.

During 1001, the apparatus receives, from a geostationary first access node, a user context that defines a radio resource control connection between the geostationary first access node and a user equipment, and an indication that the user context is to be provided to a non-geostationary second access node. The user context may be a radio access context, as discussed above,

During 1002, the apparatus causes the user context to be provided to the non-geostationary second access node.

The causing the user context to be provided to a non-geostationary second access node may comprise: providing the user context to a second proxy node with an indication that the user context is to be provided to the non-geostationary second access node.

The causing the user context to be provided to a non-geostationary second access node may comprise providing the user context directly to the non-geostationary second access node.

The apparatus may receive an identifier of the non-geostationary second access node from the geostationary first access node.

The apparatus may receive the identifier of the non-geostationary second access node as part of receiving a set of identifiers identifying respective access nodes.

The apparatus may provide the user context to at least two of said respective access nodes. The non-geostationary second access node may be one of said at least two of said respective access nodes. The apparatus may provide the user context to all of said respective access nodes.

The apparatus may identify the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at a time at which the user context is to be deleted by the non-geostationary second access node. The non-geostationary second access node may delete the user context from the non-geostationary second access node when said indicated time is reached.

When the user context is provided to a plurality of access nodes (e.g., at least two and/or all of the respective access nodes discussed above), each of said plurality of access nodes may be provided with respective times indicating at which time the user context is to be deleted by that access node. Each of said plurality of access nodes may be configured to delete the user context when their respective times are reached. The respective times may be different to each other.

FIG. 11 illustrates operations that may be performed by an apparatus for a non-geostationary second access node. The non-geostationary second access node may interact with the apparatus of any of FIGS. 9, 10, and/or 12.

At 1101, the apparatus receives, from a first and/or second proxy node, a user context that defines a radio resource control connection between a geostationary first access node and a user equipment. The user context may be a radio access context, as described above.

At 1102, the apparatus establishes radio resource control connection between the user equipment and the non-geostationary second access node using the user context.

At 1103, the apparatus may receive data from the non-geostationary second access node according to the radio resource control connection.

FIG. 12 illustrates operations that may be performed by an apparatus for a user equipment. The user equipment may interact with the apparatus of any of FIGS. 9, 10, and/or 11.

During 1201, the apparatus establishes a radio resource control connection with a geostationary first access node, the radio resource control connection being defined by a user context.

During 1202, the apparatus establishes a radio resource control connection with a non-geostationary second access node using the user context.

The apparatus may suspend the radio resource control connection with the geostationary first access node using a radio resource control connection suspend procedure before establishing the radio resource control connection with the non-geostationary second access node; and enter a low power state during at least part of a period of time between said suspending and said resuming.

The apparatus may receive, from the geostationary first access node, a configuration for entering the low power state.

The apparatus may receive, from the geostationary first access node, an identifier of the non-geostationary second access node with an indication of a time period during which the non-geostationary second access node is expected to be providing a cell that covers an area in which the user equipment is located.

The apparatus may: suspend the radio resource control connection with the non-geostationary second access node when a signal strength between the user equipment and the non-geostationary second access node drops below a threshold amount and/or when a link failure event occurs; and resume the radio resource control connection with the geostationary first access node using the user context.

In all of the above examples of FIGS. 9 to 12, the first and/or second proxy node may be at least one of: a ground-based gateway to a core network, a database located in a core network, an access and mobility management function, and/or a Mobility Management Entity.

In all of the above examples, the user context may comprise at least one of: a radio resource control configuration for the user equipment, access stratum security key information, and/or an identifier of an access node that was previously serving the user equipment.

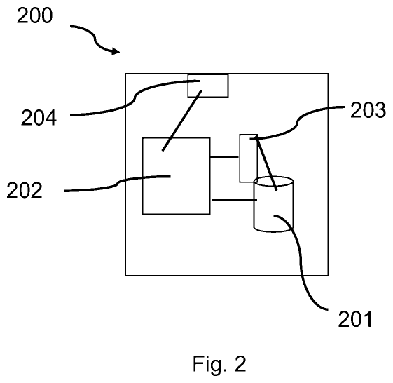

FIG. 2 shows an example of a control apparatus for a communication system, for example to be coupled to and/or for controlling a station of an access system, such as a RAN node, e.g. a base station, eNB, access point (AP), access node (AN), gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. These terms will be used herein to refer to any station of an access system and/or control apparatus. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

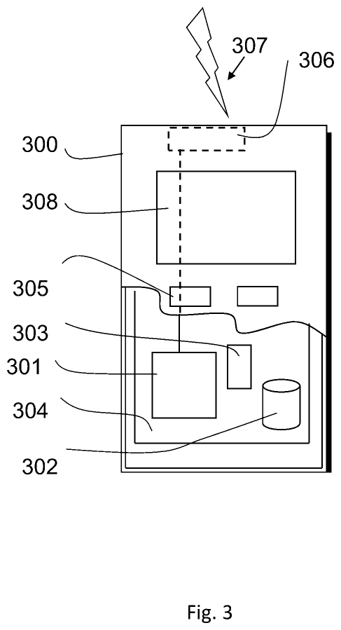

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA), vehicle, vehicle comprising a user equipment, or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or' wireless) to other devices and/or for connecting external accessories, for example hands-free equipment, thereto.

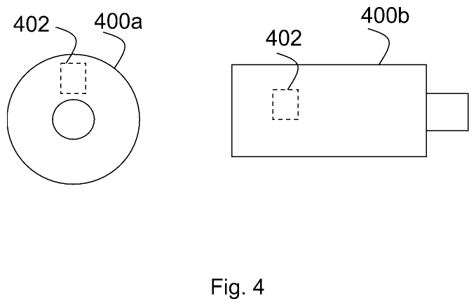

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 9, and/or FIG. 10, and/or FIG. 11, and/or FIG. 12, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 9, and/or FIG. 10, and/or FIG. 11 and/or FIG. 12, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

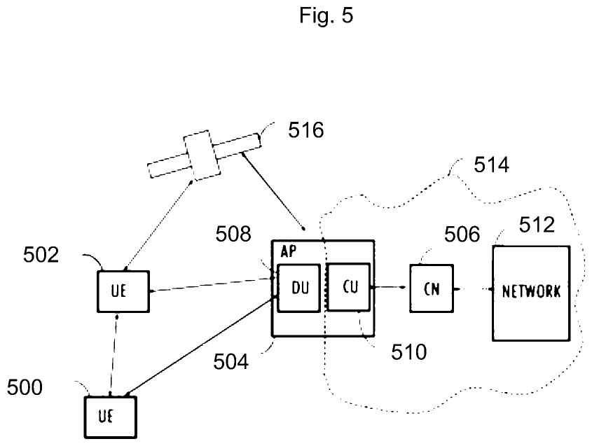

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support service link communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g)NodeB serving devices in a cell. In one example, the node 504 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 506 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, vehicle, user equipment mounted in/on a vehicle, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ—cmWave, 6 or above 24 GHz—cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g)NodeBs of FIG. 5 may provide any kind of these cells. A cellular radio system may be implemented as a multilayer network including several kinds of cells. Typically, in multilayer networks, one access node.

1. An apparatus for a geostationary first access node, the apparatus comprising at least one processor; and at least one memory comprising code that, when executed by the at least one processor causes the apparatus to perform:
establishing a radio resource control connection between the geostationary first access node and a user equipment, wherein the radio resource control connection is defined by a user context; and
providing the user equipment with information relating to when a non-geostationary second access node will be available to provide service coverage to the user equipment using the user context.

2. The apparatus as claimed in claim 1, wherein the apparatus is further caused to provide the user context to a first proxy node with an indication that the user context is to be stored for retrieval by a non-geostationary second access node.

3. The apparatus as claimed in claim 1, wherein the apparatus is further caused to perform:
determining that the non-geostationary second access node can fulfil quality of service requirements for communications to and/or from the user equipment better than the geostationary first access node can;
determining a battery status of the user equipment to be in a predetermined state and/or to have a remaining energy that is less than a threshold amount;
determining that the user equipment has indicated that the user equipment would like communications to be provided through a different radio access technology to that provided by the geostationary first access node; and/or
determining a maximum acceptable delay for information to be exchanged between the user equipment and a core network associated with the first and non-geostationary second access nodes allows for communications to be exchanged through the non-geostationary second access node.

4. The apparatus as claimed in claim 1, wherein the apparatus is further caused to perform:
identifying the non-geostationary second access node and/or an apparatus comprising the non-geostationary second access node; and
providing an indication of the non-geostationary second access node and/or the apparatus comprising the non-geostationary second access node to a first proxy node.

5. The apparatus as claimed in claim 4, wherein identifying the non-geostationary second access node and/or the apparatus comprising the non-geostationary second access node comprises identifying the non-geostationary second access node and/or apparatus comprising the non-geostationary second access node based on at least one of: a current location of the user equipment, a trajectory of the user equipment, the ephemeris of the apparatus comprising the non-geostationary second access node, the non-geostationary second access node's trajectory and/or velocity, locations of ground-based gateways to a core network, and/or characteristics of traffic to be transmitted and/or received by the user equipment.

6. The apparatus as claimed in claim 1, wherein the apparatus is further caused to perform:
suspending the radio resource control connection with the user equipment after providing the user equipment with information relating to when the non-geostationary second access node will be available to provide service coverage to the user equipment using the user context; and
subsequently resuming the radio resource control connection with the user equipment using the user context when the non-geostationary second access node is expected to no longer provide a cell covering a location in which the user equipment is located.

7. The apparatus as claimed in claim 6, wherein the apparatus is further caused to perform:
signalling, to the user equipment, a configuration for causing the user equipment to enter a low power state after said determining to suspend.

8. The apparatus as claimed in claim 1, wherein the apparatus is further caused to perform:
signalling, to the user equipment, an identifier of the non-geostationary second access node with an indication of a time period during which the non-geostationary second access node is expected to be providing a cell that covers an area in which the user equipment is located.

9. The apparatus as claimed in claim 8, wherein signalling the identifier of the non-geostationary second access node to the user equipment comprises signalling the identifier of the non-geostationary second access node and said time period during which the non-geostationary second access node is expected to be providing said cell as part of a radio resource control connection release message.

10.-12. (canceled)

13. An apparatus for a first proxy node, the apparatus comprising at least one processor; and at least one memory comprising code that, when executed by the at least one processor causes the apparatus to perform:
receiving, from a geostationary first access node, a user context that defines a radio resource control connection between the geostationary first access node and a user equipment, and an indication that the user context is to be provided to a non-geostationary second access node; and
causing the user context to be provided to the non-geostationary second access node.

14. The apparatus as claimed in claim 13, wherein causing the user context to be provided to a non-geostationary second access node comprises:
providing the user context to a second proxy node with an indication that the user context is to be provided to the non-geostationary second access node.

15. The apparatus as claimed in claim 13, wherein causing the user context to be provided to a non-geostationary second access node comprises:
providing the user context directly to the non-geostationary second access node.

16. The apparatus as claimed in claim 13, wherein the apparatus is further caused to receive an identifier of the non-geostationary second access node from the geostationary first access node.

17. The apparatus as claimed in claim 16, wherein the apparatus is further caused to receive the identifier of the non-geostationary second access node as part of receiving a set of identifiers identifying respective access nodes.

18.-21. (canceled)

22. An apparatus for a user equipment, the apparatus comprising at least one processor; and at least one memory comprising code that, when executed by the at least one processor causes the apparatus to perform:
establishing a radio resource control connection with a geostationary first access node, the radio resource control connection being defined by a user context; and
establishing a radio resource control connection with a non-geostationary second access node using the user context.

23. The apparatus as claimed in claim 22, wherein the apparatus is further caused to perform:
suspending the radio resource control connection with the geostationary first access node using a radio resource control connection suspend procedure before establishing the radio resource control connection with the non-geostationary second access node; and
entering a low power state during at least part of a period of time between said suspending and said establishing.

24. The apparatus as claimed in claim 23, wherein the apparatus is further caused to perform:
receiving, from the geostationary first access node, a configuration for entering the low power state.

25. The apparatus as claimed in claim 23, wherein the apparatus is further caused to perform:
receiving, from the geostationary first access node, an identifier of the non-geostationary second access node with an indication of a time period during which the non-geostationary second access node is expected to be providing a cell that covers an area in which the user equipment is located.

26. The apparatus as claimed in claim 22, wherein the apparatus is further caused to perform:
suspending the radio resource control connection with the non-geostationary second access node when a signal strength between the user equipment and the non-geostationary second access node drops below a threshold amount and/or when a link failure event occurs; and
resuming the radio resource control connection with the geostationary first access node using the user context.

27. (canceled)

28. The apparatus as claimed in claim 1, wherein the user context comprises at least one of: a radio resource control configuration for the user equipment, access stratum security key information, and/or an identifier of an access node that was previously serving the user equipment.

29.-36. (canceled)
